(19) United States
(12) Patent Application Publication
(10) Pub. No.: US 2009/0065538 A1
(43) Pub. Date: Mar. 12, 2009

(54) Sanding Block Leash

(76) Inventors: Jeff Rodriquez, Thornton, CO (US); Brodie Fisher, Brighton, CO (US)

Correspondence Address: Leyendecker & Lemire, LLC, C/O PORTFOLIO IP, P.O. BOX 52050, MINNEAPOLIS, MN, 55402, US

(21) Appl. No.: 11/833,877

(22) Filed: Aug. 3, 2007

(51) Int. Cl. A45F 5/00; B23P 19/04; B24B 27/08

(52) U.S. Cl. 224/267; 29/700; 451/344

(57) ABSTRACT

A sanding block leash comprising a coupling mechanism adapted to pierce a sanding block. The sanding block leash coupling mechanism if further adapted to couple to a connector section such as, but not limited to, an eleastomeric string. The connector section in one embodiment is further coupled to a strap section. The strap section of one embodiment comprising a hook and loop material strap adapted to couple to a substantially stable object such as, but not limited to, person's wrist or may be comprised of a clip adapted to couple to an object such as, but not limited to, a belt loop.

### BACKGROUND

Drywall, commonly known as gypsum board or plasterboard, is a common building material used in the construction of interior walls. A drywall panel is typically made of a paper liner wrapped around an inner core. The inner core may be comprised of dried gypsum plaster—a semi-hydrous form of calcium sulphate. The name drywall derives from the material's replacement of the lath and plaster wall building method—where wet plaster is spread over thin, narrowly-spaced wooden boards. The gypsum plaster of the inner core of drywall may be mixed with a fibrous mixture which may comprise paper and fiberglass. A foaming agent, additives to increase mildew and fire resistance, and water may also be mixed with the plaster.

Using drywall as a building material for interior walls is typically more efficient than using wet a plaster application. For example, installing drywall may take one or two days for a couple of experienced drywallers, whereas the same walls make take up to a week to install if a plaster application is applied. Additionally, drywall is generally easy enough to install that many amateur home carpenters can adequately set up a room using drywall.

In large-scale commercial construction, the work of installing and finishing drywall is often split between drywall mechanics/hangers and drywall tapers/mudmen. The mechanics install the drywall sheets, oftentimes using drywall nails, while the tapers finish and cover the nail heads and seams between drywall sheets with drywall compound, sometimes called “mud”. This compound is often also applied to any defects in the boards as well.

After applying the compound, the mud is typically allowed to air dry and subsequently sanded smooth before painting. In alternative applications, an entire walled section of drywall may be given a thin “skim” coat of drywall compound. Such a skim coat may be about 1/16 of an inch thick. Skim coats minimize the visual differences between the paper and mudded areas after painting.

In either application, upon applying the compound and letting it dry, the compound is sanded. Very fine sandpaper is typically used. One type of sandpaper used in leveling drywall compound may have a grit level of about 220. Sanding blocks comprised of a foam core having a sanding grit embedded in a polymeric binder coupled to its exterior are often used by tapers and mudmen. Foam sanding blocks permit even sanding on both smooth and contoured surfaces. Sanding blocks also allow painters to help prepare and finish their work.

During sanding, some drywall applications may require the mudmen and tapers to wear stilts or require the use of scaffolding and/or ladders to reach the upper portions of the mudded sections of drywall. Sanding blocks are occasionally dropped during the sanding portion of these drywall sections. This may result in a substantial loss of time and therefore money since extensive time may be lost in retrieving the sanding block when the stilts must be taken off or the ladder or scaffolding must be scaled.

### SUMMARY OF THE DRAWINGS

FIG. 1 is an isometric view of a sanding block leash coupled to a sanding block according to one embodiment of the invention.

FIG. 2 are front views of various coupling mechanisms according to different embodiments of the invention.

FIG. 3 is a series of front views of a sanding block showing the coupling mechanism piercing the sanding block surface according to one method of the invention.

FIG. 4 is a side view of a sanding block leash having a clip strap section according to one embodiment of the invention.

FIG. 5 is an isometric view of a person dropping a sanding block and the sanding block being caught by a sanding block leash coupled to the person's wrist according to one method of the invention.

FIG. 6 is an isometric view of a non-rectangular sanding block/sponge according to one embodiment of the invention.

FIG. 7 is a sanding block leash having only a coupling mechanism and connector section according to one embodiment of the invention.

### DETAILED DESCRIPTION

One embodiment of a sanding block leash is comprised of a coupling mechanism, a connector section, and a strap section. One coupling mechanism may be adapted to couple to a sanding block. For example, an embodiment's coupling mechanism may couple to a sanding block by piercing a sanding block surface. The connector section of an embodiment may couple to the coupling mechanism and to the strap section. One connector section may be comprised of an elastomeric string threaded through a coupling mechanism bore and a strap section bore. Lastly, the strap section may be a strap comprised of hook and loop material. However, strap sections may not be a strap, but may be comprised of a clip. One strap section may be adapted to couple to a person's wrist, a belt loop, or any other substantially stable object.

One embodiment's coupling mechanism may pierce the surface of a sanding block through rotational pressure on at least a portion of the coupling mechanism. For example, one coupling mechanism may be comprised of a screw. An elastomeric string connector section may be tied to a screw head reception area. Other coupling mechanisms may not require rotational pressure. For example, coupling mechanisms may be comprised of hooks, clasps, or other devices adapted to pierce the surface of a sanding block without rotation.

One connector section may couple to the coupling mechanism through a coupling mechanism bore. For example, upon insertion of a coupling mechanism to a sanding block, a portion of the coupling mechanism may extend out of the sanding block surface. The coupling mechanism portion extending out of the block may be comprised of the coupling mechanism bore. If the connector section is an elastomeric string, a string proximal end may wrap through the bore and back towards a string center portion. The connector section string proximal end may then be crimped to the string center portion. Likewise, an elastomeric string distal end may wrap through a strap section bore and operatively couple via a crimp to the string center portion.

One strap section may be comprised of a strap having two sides. A strap first side may be comprised of a hook material and a strap second side may be comprised of a loop material. The strap may be wrapped around a user's wrist so that the strap generally resembles a bracelet. At this point the hook material may couple to the loop material, keeping the strap, and thereby connector section and sanding block, coupled to the person's wrist in the event the sanding block is dropped.

Upon inserting a coupling mechanism to a sanding block, one method of operatively coupling a leash to a sanding block is further comprised of coupling a strap portion to a generally stationary object. A method of inserting the coupling mechanism to the sanding block may include rotatably screwing the coupling mechanism into a foam portion of a sanding block. The step of coupling the strap portion to a generally stationary object may include wrapping a strap section having a hook-loop material around a person's wrist. Coupling a strap section not comprised of a strap but comprised, among other things, a spring-loaded clip, to other objects besides a person's wrist is also contemplated.

In coupling a sanding block leash to a sanding block and to a generally stationary object, problems previously encountered by painters, mudmen and tapers may be overcome. For example, when painters, mudmen and tapers are positioned high atop scaffolding or on a ladder, or when wearing stilts, there will be no need to track down a dropped sanding block, because the block will be attached to the person's body, or to the ladder or scaffolding itself, among other locations. For large commercial projects, this will lead to more efficient drywall installations, thereby saving money as less time will be spent on each drywall application.

### Terminology:

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

The term “couple” or “coupled” as used in this specification and the appended claims refers to either an indirect or direct connection between the identified elements, components or objects. Often the manner of the coupling will be related specifically to the manner in which the two coupled elements interact.

The term “integrate” or “integrated” as used in this specification and the appended claims refers to a blending, uniting, or incorporation of the identified elements, components or objects into a unified whole.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

As applicable, the terms “about” or “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied.

### One Embodiment of a Sanding Block Leash:

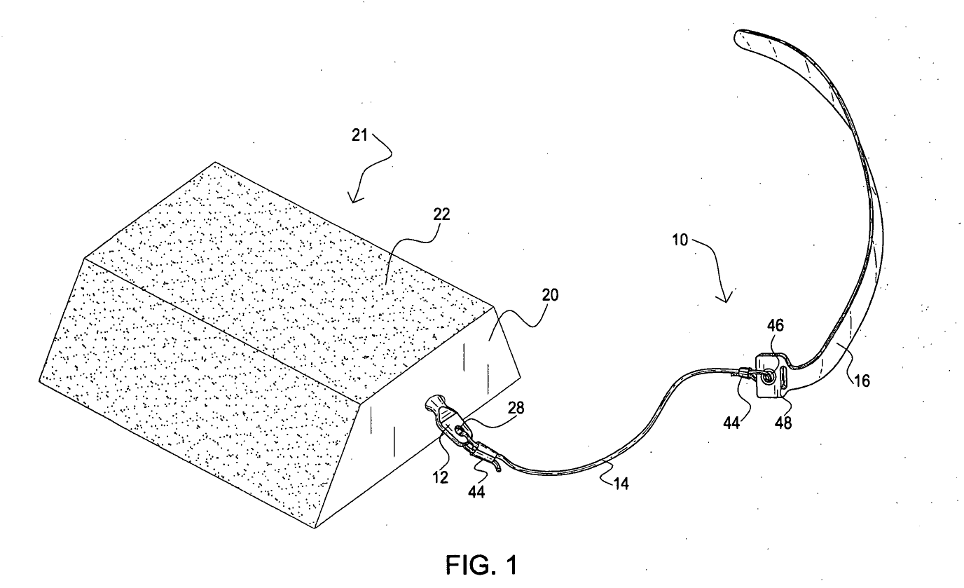

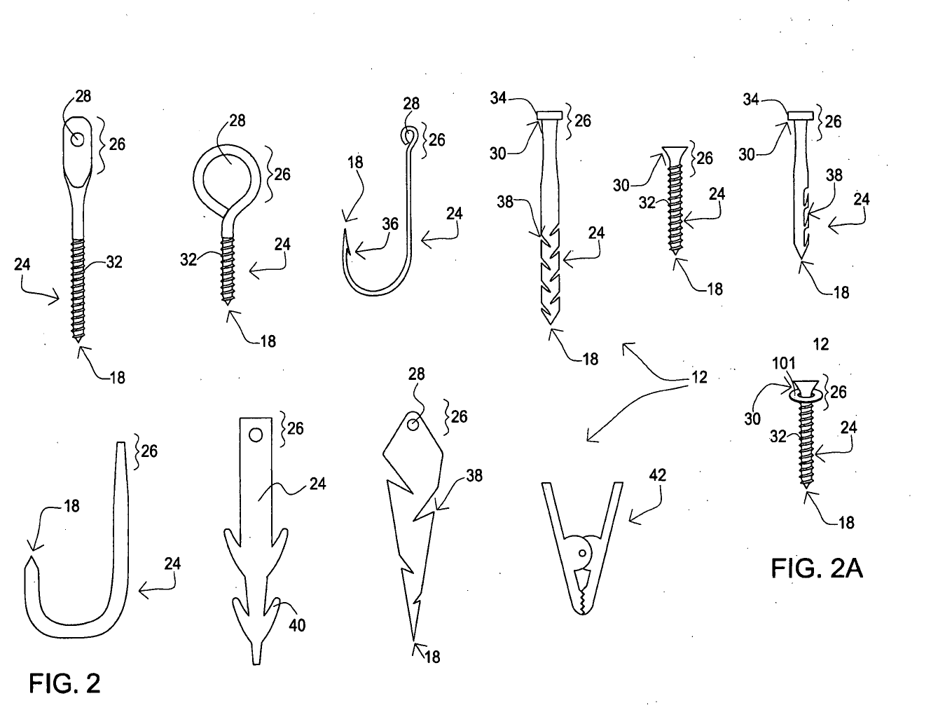

As best shown in FIGS. 1 and 2, a sanding block leash 10 may be comprised of a coupling mechanism 12, a connector section 14, and a strap section 16. One coupling mechanism may be comprised of a pointed tip 18. A pointed tip may be adapted to pierce a sanding block surface 20. For example, the sanding block 21 may be comprised of a foam material or may be referred to as a sanding sponge. An exemplary type of sanding block which may be used is Drywall Sanding Sponge CP042 made by 3M Corporation of St. Paul, Minn. Likewise, the surface which may be pierced by the pointed tip may be comprised of the foam material. In one embodiment, the surface pierced by the tip may be a sanding grit encrusted surface also known as a sand paper surface 22. The sand paper surface may be comprised of a surface having a course texture. For example, sandpaper may be coupled to a foam block through an adhesive to create a sanding surface in one embodiment. The sanding block 21 of one embodiment may be comprised of a resilient foam material as opposed to rigid foam. The resilient foam may allow for a sander or painter to sand corners and other difficult to reach places. One embodiment of a sanding block leash may be comprised of a coupling mechanism adapted to coupled to a sanding block for use with fiberglass, carpenters, or in automotive or marine applications. Additionally, although various sanding blocks and sponges are described herein as a rectangular sanding block, non-rectangular sanding blocks are also contemplated, some with a grit level of or about 60. In one embodiment, a heavy grit level may constitute a grit of about 100 or less, a medium grit may constitute a grit of about 100 to about 150, and a fine grit may constitute a grit level larger than about 150.

As best shown in FIG. 2, one coupling mechanism 12 may also be comprised of a stem portion 24. The stem portion may be integrated to the pointed tip 18 and extend from the pointed tip to a reception area 26. The reception area may be comprised of a coupling mechanism bore 28. Alternatively, the reception area may be comprised of a lip 30. Both the lip and the bore, or any other reception area design may be adapted to couple to a connector section 14 in one embodiment. For example, as best shown in FIG. 1, the connector section may be comprised of an elastomeric string, and a string proximal end may be threaded through the bore. Non-elastomeric connector sections are also contemplated. The string proximal end may then be tied, crimped, or otherwise operatively coupled to a string center portion. Alternatively, the string may also be tied around the lip. Other connector sections may couple to the coupling mechanism in a different manner. For example, a snappably coupled connector section may be used.

The stem portion 24 of one embodiment may be comprised of helical threads 32. For example, one coupling mechanism may be comprised of a stem portion having helical threads generally like a screw wherein the threads may generally encircle the stem portion. Besides helical threads generally encircling the stem portion of one embodiment, other embodiment stem portions may be comprised of a general hook-shape with a barb 36, may have jagged grooves 38, or may have any other design adapted to pierce or couple to a sanding block, as best shown in FIG. 2. One type of stem portion is adapted to keep the coupling mechanism lodged in the sanding block. For example, the jagged grooves may extend from a location proximal a stem portion centerline outwardly to a stem portion edge. Additionally, the grooves 38 may be angled from the pointed tip 18 towards a coupling mechanism head 34.

The shape of the coupling mechanism 12 may be adapted to keep the coupling mechanism lodged in the sanding block 21 when the sanding block is dropped. For example, when the sanding block is dropped by a mudman or taper, the coupling mechanism must stay lodged in the sanding block upon being caught by the connection section 14. The coupling mechanism in one embodiment is adapted to stay lodged within the sanding block upon multiple drops by a mudman or taper.

Coupling mechanisms may also have extensions 40 or may be generally shaped as a clip 42. One type of clip that may be used is an alligator clip. Whatever the design of the coupling mechanism, it may be adapted to stay lodged with a sanding block when the block is dropped by a person and the connector section is operatively coupled to a substantially stable object. Alternatively, the coupling mechanism may not be lodged within the sanding block, but may simply be coupled to the sanding block. For example, the coupling mechanism in one embodiment may be a clamping device. One coupling mechanism maybe a screw 3 inches long and having a ¼ inch thread outer diameter.

As best shown in FIG. 1, one embodiment's connector section 14 may be comprised of a string. The string may be comprised of an elastomeric material. For example, one string may be comprised of a bungee cord having a diameter of about 1/32 inch and a length of about 9 inches. Other connector section diameters may be as thick as ⅛ of an inch and as long as 2 feet.

The connector section 14 in one embodiment may also be comprised of at least one crimp 44. One crimp may also be referred to as a clasp. Two crimps may be threaded or placed onto the string and placed in or proximal a connector section center portion. A connector section proximal end may then be threaded through the coupling mechanism bore 28 and a connector section distal end may be placed through a strap section bore 46. The two connector section ends may then be wrapped back towards the connector section center portion. Each end may then be threaded or placed onto a crimp, respectively. The crimps may then be tightened around the connector section center portion and the proximal end and distal end—proximal the ends themselves—keeping the connector section coupled to the coupling mechanism and strap section.

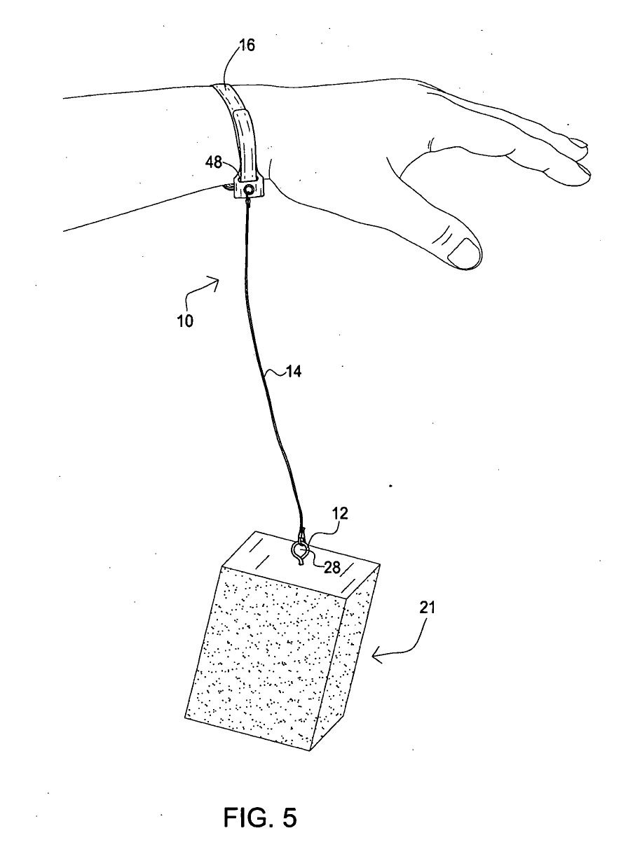

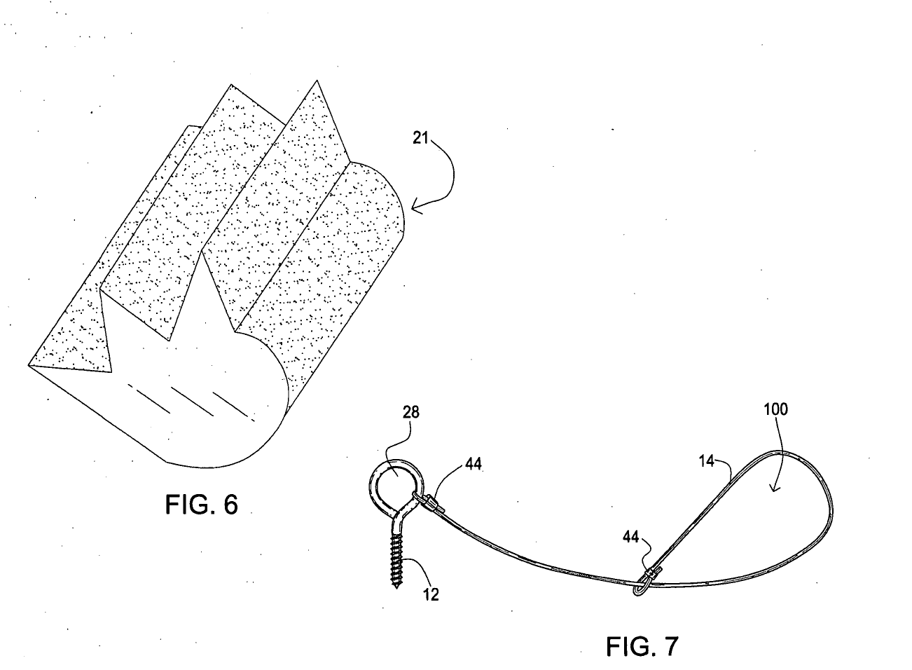

The strap section 16 of one embodiment may be comprised of hook-loop material. Other strap sections may be comprised of spring-loaded clips, as best shown in FIG. 4. One strap section, as shown in FIG. 1, may have a strap section bore 46 and may also have a strap section slot 48. A first side of the strap section may be comprised of a hook portion of the hook-loop material and a second side of the strap section may be comprised of a loop portion of the hook-loop material. As best shown in FIG. 5, the first side may be wrapped around an object such as, but not limited to, a person's wrist, threaded through the slot 48 and placed on the second side, thereby coupling the hook material to the loop material. When the sanding block is dropped, the connector section coupled to the block and the strap section catches the block. One type of hook-loop material that may be used is Velcro®.

### One Method of a Coupling a Leash to a Sanding Block:

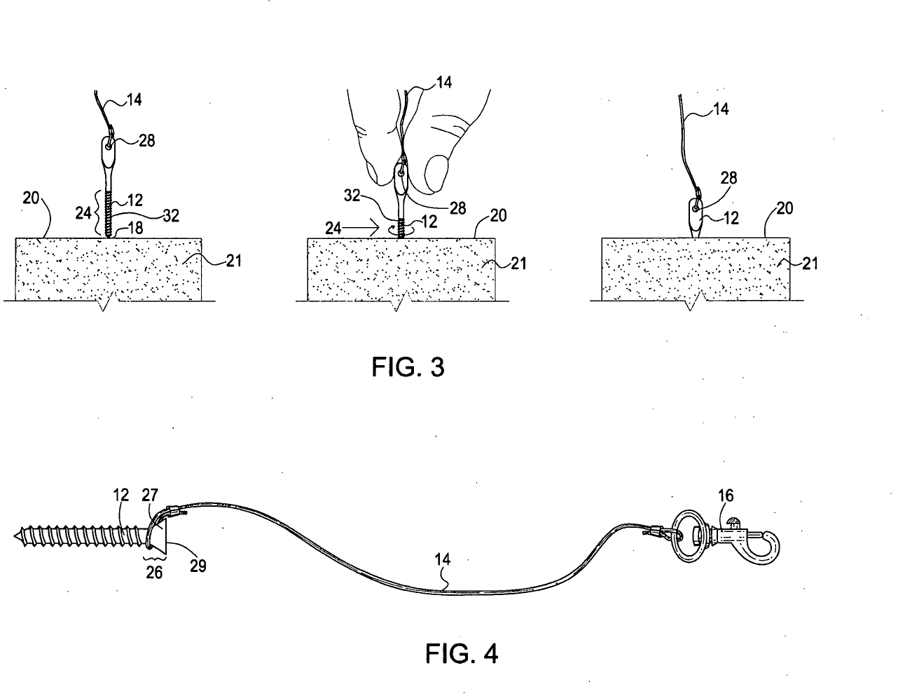

As best shown in FIGS. 3 and 5, one method of coupling a sanding block leash 10 to a sanding block 21 may comprise using a sanding block leash having a coupling mechanism 12, a connector portion 14, and a strap section 16. The method may include inserting a portion of a coupling mechanism into the sanding block 21. A method may also include coupling the strap section to a generally stable object such as, but not limited to, a person's wrist. The method may further include coupling the connector section to the coupling mechanism and the strap section. In one embodiment, the coupling mechanism may directly couple to the strap section without the need for a connector section.

One method's connector section 14 may be comprised of a string. The string may be comprised of an elastomeric material. Coupling to an end of one embodiment's string connector section may be the coupling mechanism 12. The coupling mechanism may be coupled to the connector section string proximal end. The other end of the string may be a distal end. The distal end may be coupled to the strap section 16. For example, one method may be comprised of inserting the connector section string proximal end through a coupling mechanism bore 28, inserting the connector section string distal end through a strap section bore 46, and crimping the connector section string proximal end and distal end to a connection section center portion, respectively.

Alternatively, as best shown in FIG. 4, the coupling mechanism 12 may not have a coupling mechanism bore 28. In such an embodiment, the connector section 14 may couple to the coupling mechanism by tying to the coupling mechanism at or near a coupling mechanism reception area 26. One coupling mechanism reception area may have a flanged lip 27 generally encircling a coupling mechanism distal end 29. This distal end may be referred to as a second end and a coupling mechanism proximal end may be referred to as a first end. The flanged lip may be adapted to prohibit the connector section such as, but not limited to, a connector section elastomeric string from uncoupling from the coupling mechanism. For example, the lip may prohibit the strip from sliding off the coupling mechanism distal end.

In one method, the leash 10 may couple to a sanding block 21 comprised of a foam material. Other sanding block materials such as, but not limited to, wood or polymeric materials are also contemplated. In one method, to couple the leash to the sanding block, a portion of a coupling mechanism 12 may be inserted into the sanding block. For example, a method may include placing a coupling mechanism proximal end on a sanding block surface 20. The coupling mechanism proximal end may also be referred to as the first end and may have a pointed tip 18.

In one method, a coupling mechanism first end may be firmly pressed into the sanding block foam material. A method may include rotatably coupling the coupling mechanism to the sanding block. For example, as best shown in FIG. 3, the coupling mechanism may have at least one helical thread 32 encircling the coupling mechanism stem portion 24. One coupling mechanism may be a screw. The coupling mechanism may be rotated in a first direction, which may be a clockwise rotation, as the pointed tip 18 is pressed firmly into the sanding block. Upon insertion of the pointed tip to the block, the helical thread may begin to couple to the sanding block surface 20. Continuing to rotate the coupling mechanism, the helical thread may pull the coupling mechanism into the sanding block.

In one method, the strap section 16 may be an actual strap, as best shown in FIG. 5. However, the strap section in other embodiments may not be a strap, but may be a clip. For example, as best shown in FIG. 4, the strap section is a spring-loaded clip. The strap section of one embodiment may be comprised of hook loop material such as, but not limited to, Velcro®, adapted wrap around an object such as, but not limited to, a person's wrist. In one method a strap section hook material side may be placed around a person's wrist and a strap section end (possibly a distal or proximal end) may be placed through the strap section slot 48. The strap section end may be pulled through the slot so the strap section loop side is coupled to the strap section hook side. Alternatively, besides coupling a strap section to a person's wrist, a strap section comprising a strap, a clip, or any other type of strap section may couple to scaffolding, a ladder, a belt loop, or any other substantially stable object. It should be realized that the coupling mechanism, such as a screw, is adapted to insert, or screw, into resilient foam and stay inserted into the resilient foam upon exertion of a longitudinally-applied force to the screw or other coupling mechanism, the force being generally perpendicularly-applied to the sanding block surface since one coupling mechanism's longitudinal axis may be generally perpendicular to the sanding block surface. In order to do so, some coupling mechanism threads may be generally course threads. One sanding block may weigh about 1.3 ounces and have only 4 abrasive sides.

A method may also include using a sanding block leash 10 which does not comprise a connector section 14 or a strap section 16. In such a method, either the strap section 16 may be coupled to the coupling mechanism 12, or the connector section may be coupled to the substantially stable object such as, but not limited to, a person's wrist. For example, as best shown in FIG. 7, the connector section 14 is looped back and coupled to itself, creating a loop portion 100 for a person's wrist or other substantially stable object to fit within. Additionally, as best shown in FIG. 2A, one coupling mechanism 12 may include a washer 101. In one embodiment, the washer may couple to the connector section.

### ALTERNATIVE EMBODIMENTS

The embodiments of the sanding block leash and methods of use as illustrated in the accompanying figures and described above are merely exemplary and are not meant to limit the scope of the invention. It is to be appreciated that numerous variations to the invention have been contemplated as would be obvious to one of ordinary skill in the art with the benefit of this disclosure.

I claim:

1) A sanding block leash comprising,
a coupling mechanism having a pointed tip adapted to pierce a sanding block;
a connector section comprising a flexible material; and
a strap section adapted to couple to a generally stable object.

2) The sanding block leash of claim 1 wherein,
the coupling mechanism is comprised of a screw, the screw adapted to rotatably pierce a sanding block surface, and
the strap section is a lanyard.

3) The sanding block leash of claim 1 wherein,
the connector section comprises an elastomeric string having a proximal end, a distal end, and a center portion, the connector section further including at least one crimp and adapted to couple to a coupling mechanism bore and a strap section bore;
the coupling mechanism comprising,
a first end, the first end including the pointed tip,
a second end, the second end including a reception area,
a stem section having helical threads, and
a bore.

4) The sanding block leash of claim 1 wherein, the strap section (i) comprises a hook and loop material strap having a bore and a slot, the slot adapted to receive a strap section end, and (ii) is adapted to couple to a person's wrist.

5) A method of coupling the sanding block leash of claim 1 to a sanding block, the method comprising,
coupling the connector section to (i) the coupling mechanism and (ii) the strap section;
inserting a portion of the coupling mechanism into the sanding block; and
coupling the strap section to a generally stable object.

6) The method of claim 5 wherein, said coupling the connector section to the coupling mechanism and the strap section comprises,
inserting a connector section elastomeric string proximal end through a coupling mechanism bore;
inserting a connector section elastomeric string distal end through a strap section bore; and
crimping the connector section proximal end and the distal end to a connection section center portion.

7) The method of claim 5 wherein, said inserting a portion of a coupling mechanism into the sanding block comprises,
placing a coupling mechanism first end on a sanding block surface,
pressing a coupling mechanism first end pointed tip into the sanding block surface; and
rotating the coupling mechanism in a first direction.

8) The method of claim 5 wherein, coupling the strap section to a generally stable object comprises,
placing a strap section hook side on a person's wrist;
wrapping the strap section substantially around the person's wrist;
pulling a strap section proximal end through a strap section slot; and
coupling a strap section loop side to the strap section hook side.

9) The method of claim 5, further including,
dropping the sanding block; and
keeping the sanding block substantially lodged within the sanding.

10) A combination comprising a sanding block leash of claim 1 and further including a sanding block.

11) The combination of claim 10 wherein, the sanding block comprising,
a generally rectangularly-shaped resilient foam material having at least one angled side;
at least one outer surface being a sanding surface; and wherein,
the sanding block is adapted to prevent one of a taper and a painter from dropping a sanding block.

12) A method of coupling a sanding block to a generally stationary object, the method comprising,
piercing a sanding block outer surface with a sanding block leash, the sanding block leash comprising,
a coupling mechanism,
coupling mechanism having a pointed tip;
inserting a portion of a sanding block leash coupling mechanism into a sanding block interior in a manner adapted to keep the coupling mechanism substantially lodged within the sanding block if the sanding block is dropped; and
coupling a sanding block leash strap section to the generally stationary object.

13) The method of claim 12 further including,
dropping the sanding block; and
stretching an elastomeric sanding block leash connector section.

14) The method of claim 13 wherein, the sanding block having at least a medium grit.

15) A combination comprising,
a sanding block comprising
a resilient foam material, and
a sanding surface; and
a sanding block leash comprising,
a coupling mechanism coupled to the sanding block having
a pointed tip,
a bore comprising an eyelet, and
a stem portion,
an elastomeric connector section coupled to (i) the coupling mechanism and (ii) a strap section, wherein
the strap section is coupled to a substantially stable object.

16) The combination of claim 15 wherein,
the sanding block further comprises,
a generally rectangular shape,
at least one angled surface, and
a sanding surface having a heavy grit; and
the coupling mechanism further comprising,
a helical thread, and wherein,
the bore is located proximal a coupling mechanism reception area.

17) The combination of claim 15 wherein,
the generally rectangular sanding block having
a length of about 5 inches,
a width of about 3 inches,
a thickness of about 1 inch; and
the elastomeric connector section generally comprising
a length of about 1 foot,
a diameter of about ⅛ inches.

18) The combination of claim 15 wherein, the coupling mechanism comprises a hook.

19) The combination of claim 15 wherein, the strap section comprises a clip.

20) The combination of claim 15 wherein, the sanding block is (i) adapted to prevent a taper from dropping a sanding block, and (ii) comprised of a generally rectangularly-shaped foam material having at least one angled side.
